(19) United States
(12) Patent Application Publication
(10) Pub. No.: US 2015/0346137 A1
(43) Pub. Date: Dec. 3, 2015

(54) LIQUID SENSOR

(71) Applicant: Aisan Kogyo Kabushiki Kaisha, Obu-shi (JP)

(72) Inventor: Nobuhiro Kato, Tokai-shi (JP)

(21) Appl. No.: 14/723,078

(22) Filed: May 27, 2015

(30) Foreign Application Priority Data
May 29, 2014 (JP) 2014-111710

(51) Int. Cl. G01N 27/403

(52) U.S. Cl. CPC G01N 27/403

(57) ABSTRACT

A liquid sensor may be provided with a lid disposed at an opening of the container, and having an insertion hole; a control circuit; a case housing the control circuit, and being assembled with the lid; a first electrode integrally fixed to the case, and protruding from the case so as to be positioned on a container side of the insertion hole; a second electrode integrally fixed to the lid, and opposing the first electrode with an interval in between; and a terminal extending from the control circuit and piercing the case, and electrically in contact with the second electrode.

### CROSS-REFERENCE TO RELATED APPLICATION

This application claims priority to Japanese Patent Application No. 2014-111710 filed on May 29, 2014, the contents of which are hereby incorporated by reference into the present application.

### TECHNICAL FIELD

The application discloses a liquid sensor configured to detect a property of the liquid within a container.

### DESCRIPTION OF RELATED ART

Japanese Patent Application Publication No. 2013-195160 discloses a fuel sensor that includes a tubular-shaped outer electrode, an inner electrode disposed inside the outer electrode and a resin member supporting the outer electrode and the inner electrode. Between the inner wall of the outer electrode and the outer wall of the inner electrode, a predetermined gap that uses a fuel as a dielectric material and that can detect a capacitance is provided. The outer electrode and the inner electrode are attached to the resin member by insert molding.

### SUMMARY

In the technology described above, all electrodes disposed in the fuel sensor are attached to the resin member by insert molding. In this configuration, it is necessary to perform the insert molding in a state where all the electrodes are appropriately positioned within a forming mold.

The present specification discloses a technology for appropriately acquiring an interval between electrodes disposed in a liquid sensor.

The application discloses a liquid sensor configured to detect a property of the liquid within a container. The liquid sensor may comprise a lid disposed at an opening of the container, and having an insertion hole; a control circuit; a case housing the control circuit, and being assembled with the lid; a first electrode integrally fixed to the case, and protruding from the case so as to be positioned on a container side of the insertion hole; a second electrode integrally fixed to the lid, and opposing the first electrode with an interval in between; and a terminal extending from the control circuit and piercing the case, and electrically in contact with the second electrode.

In the configuration described above, the interval between the first electrode and the second electrode is determined by an attachment position of the case when the case is attached to the lid. In this configuration, the case is attached to the lid at an appropriate position, as a result of which the interval between the first and second electrodes may be appropriately acquired without performing the insert molding in which both the first and second electrodes are disposed within a forming mold.

### BRIEF DESCRIPTION OF DRAWINGS

FIG. 1 shows a configuration in the vicinity of a fuel tank;

FIG. 2 shows a configuration of a fuel sensor unit in a first embodiment;

FIG. 3 shows a configuration of a fuel sensor unit in a second embodiment;

FIG. 4 shows a configuration of a fuel sensor unit in a third embodiment;

FIG. 5 shows a configuration of a fuel sensor unit in a fourth embodiment;

FIG. 6 shows a configuration of a fuel sensor unit in a fifth embodiment;

FIG. 7 shows a configuration of a fuel sensor unit in a variation of the fifth embodiment;

FIG. 8 shows a configuration of a fuel sensor unit in a variation of the fifth embodiment;

FIG. 9 shows a configuration of a fuel sensor unit in a variation of the fifth embodiment;

FIG. 10 shows a configuration of a fuel sensor unit in a variation of the fifth embodiment;

FIG. 11 shows a configuration of a fuel sensor unit in a sixth embodiment;

FIG. 12 shows a configuration of a fuel sensor unit in a variation; and

FIG. 13 shows a cross-sectional view taken along line XIII-XIII in FIG. 12.

### DETAILED DESCRIPTION

Some features of embodiments described herein will be listed. Notably, technical features described herein are each independent technical element, and exhibit technical usefulness thereof solely or in combinations.

(Feature 1) In the liquid sensor, the lid may comprise a recess housing the first electrode on the container side of the insertion hole. The second electrode may be fixed to the recess. The second electrode may be fixed to the recess. In this configuration, the first electrode is housed in the recess, and thus the first electrode can be opposed to the second electrode.

(Feature 2) In the liquid sensor, the first electrode and the second electrode may define a storage space configured to store the liquid. The liquid sensor may comprise a supplying unit configured to supply an output value being output from one of the first electrode and the second electrode to a detecting unit configured to detect the property of the liquid while electric power is supplied to one of the first electrode and the second electrode. In this configuration, the first electrode and the second electrode can be utilized for detection of the property of the liquid.

(Feature 3) The liquid sensor may comprise a third electrode integrally fixed to the case, and opposing the first electrode with an interval in between; and a supplying unit configured to supply an output value outputted from one of the first electrode and the third electrode to a detecting unit configured to detect the property of the liquid while electric power is supplied to one of the first electrode and the third electrode. The first electrode and the third electrode may define a storage space configured to store the liquid. The second electrode may be a shield electrode for the first electrode and the third electrode. In this configuration, the first electrode and the third electrode can be utilized for detection of the property of the liquid. With the second electrode, it is possible to reduce production of an error in the output value outputted to either the first electrode or the third electrode.

(Feature 4) The liquid sensor may comprise a sealer disposed between the first electrode and the second electrode, and blocking the interval between the first electrode and the second electrode from communicating with a gap between the lid and the case. In this configuration, it is possible to reduce the occurrence of an event in which the liquid present between the first electrode and the second electrode passes through the gap between the lid and the case and is leaked to the outside of the container.

(Feature 5) The liquid sensor may comprise a sealer disposed between the insertion hole and the first electrode, and blocking the storage space from communicating with a gap between the lid and the case. In this configuration, it is possible to reduce the occurrence of an event in which the liquid present in the storage space passes through the gap between the lid and the case and is leaked to the outside of the container.

(Feature 6) In the liquid sensor, the second electrode may include a first surface opposing the first electrode and a second surface being on an opposite side to the first surface. The terminal may contact the second surface. At least a portion of the second surface contacting the terminal may be inclined toward the terminal in greater degree as the second surface extends farther away from the case. In this configuration, it is possible to increase the contact pressure between the terminal and the first electrode.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved liquid sensor, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The exemplary embodiments are provided so that this disclosure will be both thorough and complete, and will fully convey the scope of the liquid sensors and enable one of ordinary skill in the art to make, use and practice the liquid sensors. Like reference numbers refer to like elements throughout the various drawings.

### EMBODIMENT

### First Embodiment

The fuel supply unit 1 of the present embodiment is mounted on a vehicle such as an automobile, and supplies a fuel to an unillustrated engine. The fuel supply unit 1 includes a fuel tank 10, a fuel pump unit 30 and a fuel sensor unit 2. In the fuel tank 10, gasoline or a mixture fuel of gasoline and alcohol (for example, ethanol) is stored.

The fuel pump unit 30 includes a low-pressure filter 32, a pump main body 34, a high-pressure filter 36, a reserve cup 20, a pressure regulator 42, and a discharge port 12. The low-pressure filter 32, the pump main body 34, the high-pressure filter 36, the reserve cup 8 and the pressure regulator 42 are disposed within the fuel tank 10. The pump main body 34 sucks the fuel within the reserve cup 20 via the low-pressure filter 32 from the suction port 34a of the pump main body 34 and increases the pressure. The pump main body 34 discharges the fuel whose pressure is increased from a discharge port 34b into the case 36a of the high-pressure filter 36.

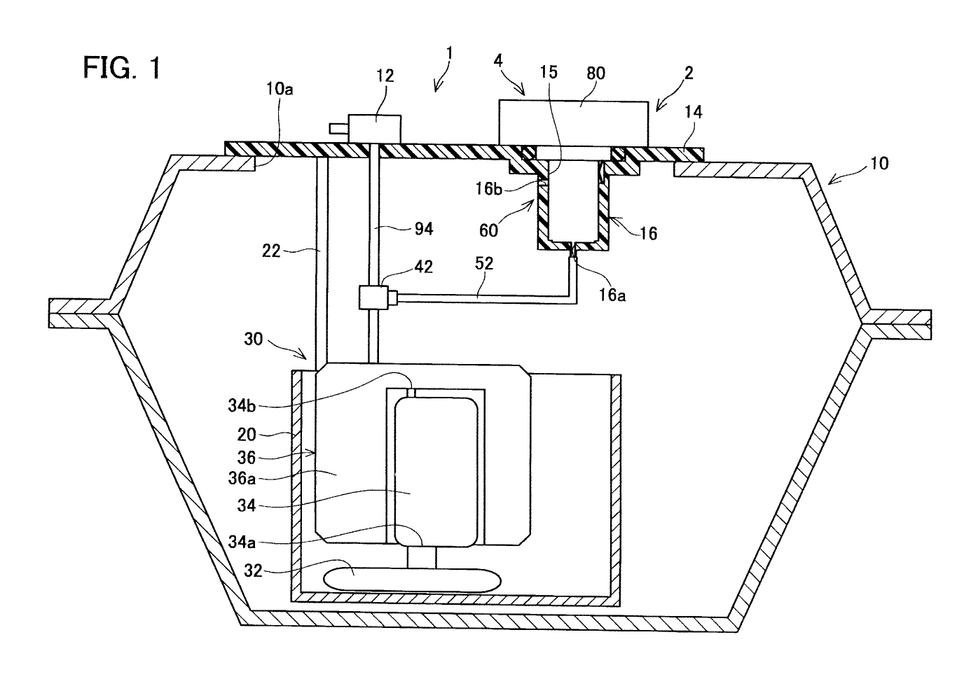

The low-pressure filter 32 is formed of nonwoven fabric into a bag shape. The interior of the low-pressure filter 32 communicates with the suction port 34a of the pump main body 34. The high-pressure filter 36 includes the case 36a and a filter member (not shown). Although not shown in FIG. 1, the case 36a is disposed in the circumferential direction of the pump main body 34. The fuel flowing into the case 36a is filtered by the filter member of the high-pressure filter 36, and is fed out via the suction port 34a to a pipe 94. The pressure regulator 42 is connected to the pipe 94. When the pressure of the fuel within the pipe 94 becomes equal to or more than a predetermined pressure, the pressure regulator 42 discharges excess fuel within the pipe 94 to a pipe 52. In this way, the pressure of the fuel within the pipe 94 is adjusted to be a constant pressure. The fuel within the fuel tank 10 is adjusted to have a constant pressure by the pump main body 34 and the pressure regulator 42 and passes from the pipe 94 through the discharge port 12 and is fed by pressure to the engine.

The pump main body 34, the high-pressure filter 36 and the low-pressure filter 32 are disposed within the reserve cup 20. The reserve cup 20 is fixed by a support column 22 to a set plate 14. By an unillustrated jet pump, fuel outside the reserve cup 20 is fed into the reserve cup 20.

The fuel sensor unit 2 includes a sensor device 4 and the set plate 14. The set plate 14 closes the opening 10a of the fuel tank 10. The set plate 14 has a disk shape. The discharge port 12, and the sensor device 4 are attached to the set plate 14.

The set plate 14 includes an insertion hole 15 and a recess 16. The insertion hole 15 is an opening that is provided in the set plate 14. The recess 16 is disposed on a fuel tank 10 side of the insertion hole 15. The recess 16 has a tubular shape with a bottom. The opening at the upper end of the recess 16 has the same diameter as that of the insertion hole 15. The pipe 52 is connected to the bottom of the recess 16. The interior of the recess 16 communicates with the pipe 52 via a communication hole 16a. In the vicinity of the upper end of the recess 16, a communication hole 16b is formed that makes the inside of the recess 16 communicate with the outside thereof.

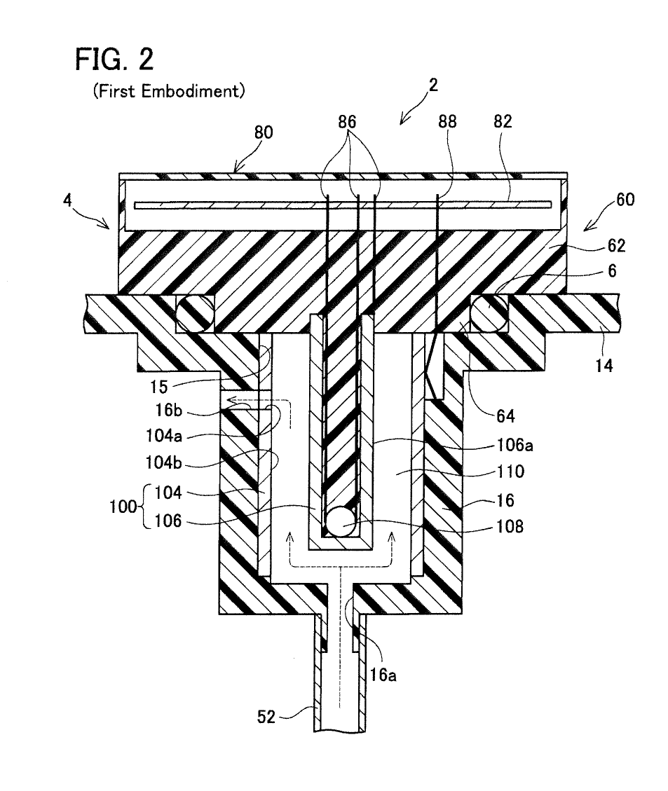

The sensor device 4 is disposed in the vicinity of the recess 16 of the set plate 14. The sensor device 4 includes a control device 80 and a sensor unit 60. As shown in FIG. 2, the sensor unit 60 includes a case 62, an electrode pair 100 and a thermistor 108.

The electrode pair 100 includes electrodes 104 and 106. Each of the electrodes 104 and 106 is formed of a material having conductivity. The electrode 104 has a cylindrical shape. The center axis of the electrode 104 is parallel to the direction of the depth of the fuel tank 10. In the vicinity of the upper end, the electrode 104 includes a communication hole 104a that makes the inside of the electrode 104 communicate with the outside thereof. The communication hole 104a is disposed so as to be continuous to the communication hole 16b of the recess 16. The electrode 104 is fixed to the inner surface of the recess 16. The upper end of the electrode 104 reaches the insertion hole 15. In other words, the inner surface of the insertion hole 15 is covered by the electrode 104. When the set plate 14 is injection-molded, the electrode 104 is fixed, by insert molding, integrally to the set plate 14. The configuration “the electrode 104 is fixed integrally to the set plate 14” includes a configuration in which, when the electrode 104 is fixed to the set plate 14, repeated attachment and removal of the electrode 104 to and from the set plate 14 cannot be performed.

The electrode 106 is disposed inside the electrode 104. The electrode 106 has a bottomed cylindrical shape having the same center axis as that of the electrode 104. The length of the electrode 106 in the direction of the center axis is shorter than that of the electrode 104 in the direction of the center axis. The upper end of the electrode 106 is located at a position higher than that of the electrode 104. The entire outer surface 106a of the electrode 106 is opposed to the inner surface 104a of the electrode 104 with a gap in between.

The thermistor 108 is disposed inside the electrode 106. The thermistor 108 is covered by a resin. The thermistor 108 is disposed at the lower end of the electrode 106. According to this configuration, a space for installing the thermistor 108 does not need to be provided outside of the electrode 106.

The upper end of the electrode 106 is supported by the case 62. In other words, the electrode 106 protrudes downwardly from the lower end of the case 62. The case 62 is formed of resin. When the case 62 is injection-molded, the electrode 106 and the thermistor 108 are fixed, by insert molding, integrally to the case 62. The hollow of the electrode 106 is filled with the resin integral with the case 62. The configuration “the electrode 106 is fixed integrally to the case 62” includes a configuration in which, when the electrode 106 is fixed to the case 62, repeated attachment and removal of the electrode 106 to and from the case 62 cannot be performed.

The case 62 is disposed above the insertion hole 15. Specifically, the case 62 is fitted via an O-ring 6 to the upper end of the recess 16. As a result that the case 62 contacts the set plate 14, the electrode 106 protruding from the case 62 is disposed beyond the insertion hole 15 within the recess 16. When the lower surface of the case 62 contacts to the set plate 14, the positioning of the case 62 is performed by the set plate 14. The case 62 is combined with the set plate 14 via a fastener member (not shown). The insertion hole 15 is blocked by the case 62. Consequently, a storage space 110 is formed by the lower end surface of the case 62, the inner surface 104b of the electrode 104, the outer surface 106a of the electrode 106 and the bottom surface of the recess 16. The upper end of the electrode 104 is pressed onto the lower surface of the case 62.

The control device 80 is disposed in the case 62. The control device 80 includes a control circuit 82, three conducting wires 86 and a terminal 88. The control circuit 82 is housed in the case 62. The control circuit 82 receives power from an unillustrated external terminal. The control circuit 82 is a circuit for supplying an electrode to the electrode pair 100 and the thermistor 108. The control circuit 82 is also a circuit for, using the sensor unit 60, detecting the temperature of the fuel and the concentration of alcohol.

The control circuit 82 is electrically connected via the three conducting wires 86 respectively to the thermistor 108 and the electrode 106 fixed to the case 62. The control circuit 82 is also connected to the terminal 88. The terminal 88 pierces the case 62 from the control circuit 82 and protrudes from the lower surface of the case 62. The lower end of the terminal 88 is in contact with the outer surface of the electrode 104. The lower end of the terminal 88 is bent such that elastic deformation of the terminal 88 is facilitated. The terminal 88 is in contact with the electrode 104 in a state where the terminal 88 is elastically deformed. With this configuration, it is possible to increase a contact force between the terminal 88 and the electrode 104.

(Operation of the Fuel Supply Unit 1)

When a driver starts the automobile, the fuel supply unit 1 is driven. As shown in FIG. 1, when the fuel supply unit 1 is driven, the pump main body 34 is activated. Consequently, the fuel within the reserve cup 20 is passed through the low-pressure filter 32 and is sucked into the pump main body 34. The fuel within the pump main body 34 is increased in pressure by impellers within the pump main body 34 and is discharged from the discharge port 34b to the high-pressure filter 36. The fuel is filtered by the filter member of the high-pressure filter 36 and is fed out to the pipe 94. Then, the fuel is supplied from the discharge port 12 to the engine.

When the pressure of the fuel within the pipe 94 becomes equal to or more than a predetermined pressure, the pressure regulator 42 discharges excess fuel within the pipe 94 to the pipe 52. As indicated by a broken arrow in FIG. 2, the fuel within the pipe 52 is passed through the communication hole 16a and flows into the storage space 110. The fuel flowing into the storage space 110 flows between the electrode 104 and the electrode 106 from below to above. Then, the fuel that had reached the upper end of the storage space 110 is passed through the communication hole 104a and the communication hole 16b, and is discharged to the outside of the storage space 110.

While the fuel supply unit 1 is being driven, the control circuit 82 uses the electrode pair 100 to detect the concentration of alcohol contained in the fuel. The control circuit 82 repeatedly performs detection of the concentration of alcohol until the engine of the automobile is stopped.

Specifically, the control circuit 82 converts power supplied via the conducting wire 86 from a battery (not shown) into a signal (that is, an alternating current) of a predetermined frequency (for example, 10 Hz to 3 MHz) and supplies it to the electrode 106. The signal supplied to the electrode 106 is returned from the electrode 104 to the control circuit 82 via the terminal 88. Consequently, charges are stored in the electrode pair 100, and thus a capacitance is produced. The control circuit 82 uses the signal returned from the electrode 104 to the control circuit 82 to calculate the capacitance of the electrode pair 100. Then, the control circuit 82 supplies direct-current power via the conducting wire 86 to the thermistor 108, and detects the temperature of the thermistor 108 from the resistance value of the thermistor 108. The temperature of the thermistor 108 is substantially equal to the temperature of the fuel within the storage space 110. Hence, the control circuit 82 detects the temperature of the thermistor 108, and thereby can detect the temperature of the fuel within the storage space 110.

Since the area between the inner surface 104a of the electrode 104 and the outer surface 106a of the electrode 106 is filled with fuel, the capacitance of the electrode pair 100 is changed according to the dielectric constant of the fuel. Since the dielectric constant of gasoline and the dielectric constant of alcohol significantly differ from each other, the dielectric constant of the fuel is changed by the concentration of alcohol. The dielectric constant of the fuel is also changed according to the temperature of the fuel. In the control circuit 82, a circuit for using the signal supplied to the electrode 106 to specify the capacitance of the electrode pair 100 and a circuit for converting the specified capacitance into the dielectric constant of the fuel are mounted. According to this configuration, the concentration of alcohol can be appropriately detected by using the electrode pair 100.

In the fuel sensor unit 2 of the present embodiment, the electrode 104 is fixed integrally to the set plate 14 by insert molding, and the electrode 106 is fixed integrally to the case 62 by insert molding. Consequently, both the electrodes 104 and 106 do not need to be fixed integrally by the concurrent insert molding to one of the set plate 14 and the case 62. Consequently, at the time of the molding, both the electrodes 104 and 106 do not need to be disposed concurrently. Consequently, when the electrodes 104 and 106 are removed from the forming mold after molding, the forming mold disposed in the gap between the electrodes 104 and 106 can be prevented from being adhered to the electrodes 104 and 106.

The positioning of the case 62 to an appropriate position is performed by the set plate 14. In this way, it is possible to appropriately acquire the positional relationship between the electrodes 104 and 106; that is, the interval between the electrodes 104 and 106 can appropriately be ensured.

(Correspondence Relationship)

The fuel sensor unit 2 is an example of the “liquid sensor.” The fuel tank 10 is an example of the “container,” and the concentration of alcohol is an example of the “property.” The set plate 14 is an example of the “lid,” and the control circuit 82 is an example of the “circuit” and the “detecting unit.” The electrodes 106 and 104 are examples of the “first electrode” and the “second electrode,” respectively. The terminal 88 is an example of the “terminal” and the “supplying unit.”

### Second Embodiment

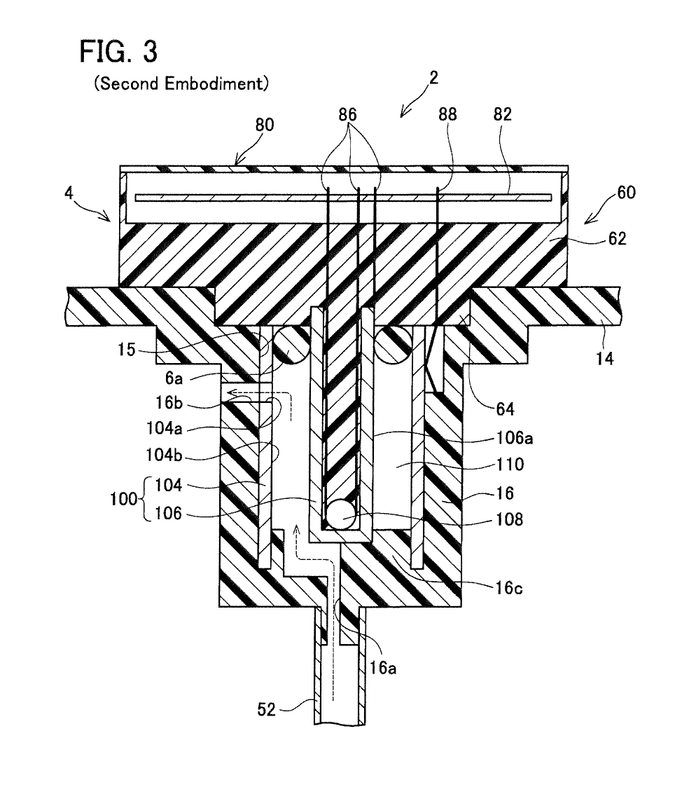

Points different from the first embodiment will be described with reference to FIG. 3. In the following discussion, the common configurations between the embodiments are identified with the same symbols, and their description is omitted. The attachment position of an O-ring 6a (an example of a “sealer”) and the configuration of the bottom surface of the recess 16 in the second embodiment are different from the first embodiment. In the second embodiment, at the upper end of the electrode 104, the O-ring 6a is disposed between the electrode 104 and the electrode 106. In this configuration, the O-ring 6a blocks the storage space 110 from communicating with a gap that may be formed between the set plate 14 and the case 62, so that no liquid can flow therebetween. In this way, it is possible to reduce the occurrence of an event in which the fuel within the storage space 110 passes through the gap between the set plate 14 and the case 62 and is discharged to the outside of the fuel tank 10.

A positioning unit 16c is disposed on the bottom surface of the recess 16. The positioning unit 16c is in contact with the lower end of the electrode 106 to locate the lower end of the electrode 106. With this configuration, it is possible to appropriately perform the positioning of the electrode 106. The case 62 is disposed with respect to the positioning unit 16c, and thus the case 62 can be attached to the set plate 14 in a state where an appropriate gap is disposed between the electrodes 104 and 106.

### Third Embodiment

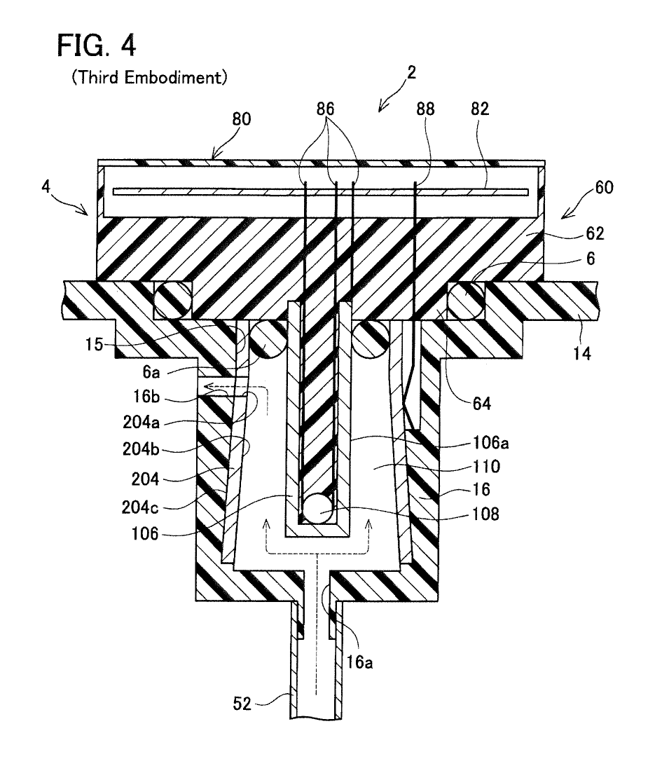

Points different from the first embodiment will be described with reference to FIG. 4. In the third embodiment, in addition to the O-ring 6, the O-ring 6a is added, and the third embodiment differs from the case in the first embodiment in which there is only one O-ring 6. An electrode 204 is different from the electrode 104 in the first embodiment.

The electrode 204 is fixed to the inner surface of the recess 16. As with the electrode 104, the electrode 204 is fixed integrally to the set plate 14. The electrode 204 includes, in the vicinity of the upper end, the same communication hole 204a as the communication hole 104a. Between the upper end of the electrode 204 and the lower end of the communication hole 204a, the electrode 204 has a cylindrical shape. Between the lower end of the communication hole 204a and the lower end of the electrode 204, as the electrode 204 extends downwardly, the diameter thereof gradually increased. Consequently, the outer surface 204c of the electrode 204 is inclined downwardly in a direction in which it is separated from the electrode 106. With this configuration, it is possible to increase the contact force with the terminal 88. The other configurations of the electrode 204 are the same as those of the electrode 104. In other words, the storage space 110 is defined by the inner surface 204b of the electrode 204, the outer surface 106a of the electrode 106, the lower surface of the case 62 and the bottom surface of the recess 16.

In a variation, as the outer surface 204c of the electrode 204 extends downwardly, the diameter thereof may gradually increase over the entire length of the electrode 204. Alternatively, between the lower end of the communication hole 204a and the lower end of the electrode 204, in a partial area including a part in contact with the terminal 88, as the electrode 204 extends downwardly, the diameter thereof may gradually increase, whereas in the other areas, the diameter may have a constant cylindrical shape. The diameter of the inner surface 204b of the electrode 204 may be constant over the entire length of the electrode 204.

As in the first embodiment, the O-ring 6 is disposed between the set plate 14 and the case 62. On the other hand, as with the O-ring 6a in the second embodiment, at the upper end of the electrode 204, the O-ring 6a is disposed between the electrode 204 and the electrode 106. In this configuration, with the two O-rings 6 and 6a, the occurrence of an event in which the fuel within the storage space 110 passes through the gap between the set plate 14 and the case 62 and is discharged to the outside of the fuel tank 10 can be suppressed.

### Fourth Embodiment

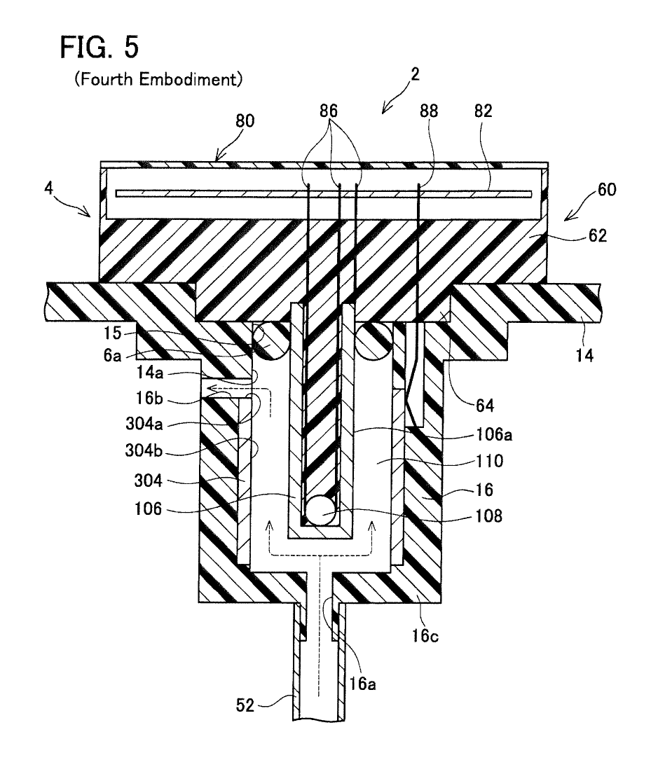

Points different from the first embodiment will be described with reference to FIG. 5. In the fourth embodiment, the attachment position of the O-ring 6a differs from that of the O-ring 6 in the first embodiment. The shape of an electrode 304 also differs from that of the electrode 104.

The electrode 304 is fixed to the inner surface of the recess 16. The upper end of the electrode 304 is disposed at the lower end of the insertion hole 15. In other words, the upper end of the electrode 304 is covered by the set plate 14. The electrode 304 has a notch 304a at the upper end. The upper end of the notch 304a is closed by the set plate 14. In this way, an opening that makes the storage space 110 communicate with the communication hole 16a is formed. The other configurations of the electrode 304 are the same as those of the electrode 104. In other words, the electrode 304 is fixed integrally to the set plate 14. The storage space 110 is defined by the inner surface 304b of the electrode 304, the outer surface 106a of the electrode 106, the lower surface of the case 62 and the bottom surface of the recess 16.

The insertion hole 15 is positioned above the electrode 304, and is opposed to the outer surface 106a of the electrode 106 with a gap in between. The O-ring 6a is disposed between the electrode 106 and the insertion hole 15. Specifically, the O-ring 6a is disposed between the outer surface 106a of the electrode 106 and the insertion hole 15. In this configuration, the occurrence of an event in which the fuel within the storage space 110 passes through the gap between the set plate 14 and the case 62 and is discharged to the outside of the fuel tank 10 can be suppressed.

### Fifth Embodiment

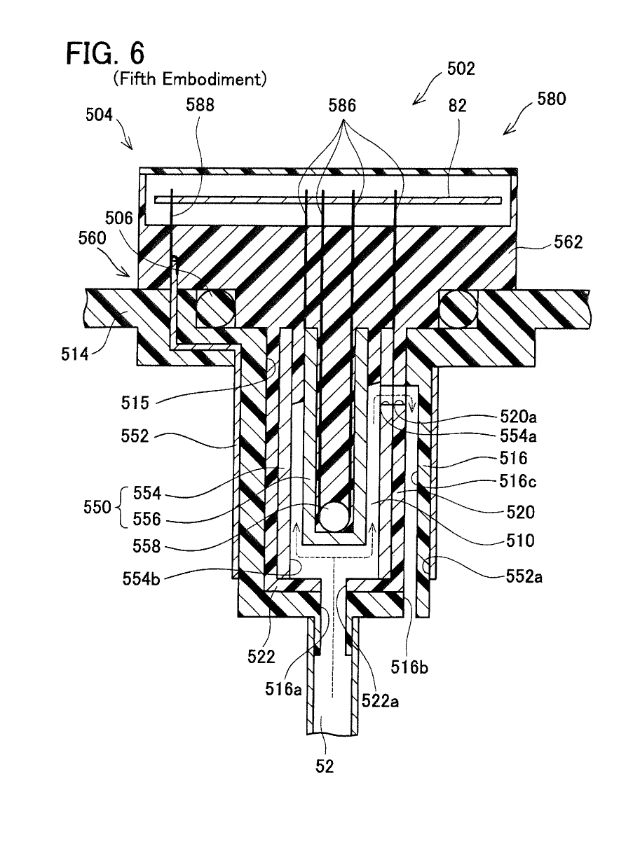

Points different from the first embodiment will be described with reference to FIG. 6. In the fifth embodiment, the configuration of a fuel sensor unit 502 differs from that of the fuel sensor unit 2 in the first embodiment. The fuel sensor unit 502 includes a sensor device 504 and a set plate 514. As with the set plate 14, the set plate 514 is disk-shaped to block the opening 10a of the fuel tank 10. The discharge port 12 and the fuel sensor unit 502 are attached to the set plate 14.

The set plate 514 includes the insertion hole 515, which is the same as the insertion hole 15 of the set plate 14, and a recess 516 that receives the fuel sensor unit 502. As with the recess 16, the recess 516 has a bottomed cylindrical shape. The bottom of the recess 516 is connected to the pipe 52, and communicates with the pipe 52 via a communication hole 516a. The bottom of the recess 516 further includes a communication hole 516b that makes the inside of the recess 516 communicate with the outside thereof.

A groove 516c is disposed in the side wall of the recess 516. The groove 516c is formed to be continuous to the communication hole 516b. The groove 516c extends upwardly from the upper end of the communication hole 516b. The upper end of the groove 516c is positioned at the same height as the upper end of a communication hole 520a of a circumferential wall 520 which will be described later.

A conductive shield electrode 552 is disposed around the outer surface of the recess 516. The shield electrode 552 has a tubular shape, and is disposed along the outer surface of the recess 516. The entire inner surface 552a of the shield electrode 552 is in contact with the outer surface of the recess 516. The shield electrode 552 extends from the upper end of the cylindrical shape, pierces the set plate 514 and protrudes upwardly of the set plate 514. When the set plate 514 is injection-molded, the shield electrode 552 is fixed, by insert molding, integrally to the set plate 514. The configuration “the electrode 552 is fixed integrally to the set plate 514” includes a configuration in which, when the electrode 552 is fixed to the set plate 514, repeated attachment and removal of the electrode 552 to and from the set plate 514 cannot be performed.

The sensor device 504 includes a control device 580 and a sensor unit 560. The sensor unit 560 includes a case 562, an electrode pair 550 and a thermistor 508.

The electrode pair 500 includes electrodes 554 and 556. Both the electrodes 554 and 556 are supported by the case 562. When the case 562 is injection-molded, the electrodes 554 and 556 are fixed, by insert molding, integrally to the case 562. The configuration “the electrodes 554 and 556 are fixed integrally to the case 562” includes a configuration in which, when the electrodes 554 and 556 are fixed to the case 562, repeated attachment and removal of the electrodes 554 and 556 to and from the case 562 cannot be performed. The shapes of the electrodes 554 and 556 are the same as those of the electrodes 104 and 106, respectively. The electrode 554 has the piercing port 554a, which is the same as the piecing port 104a of the electrode 104.

The set plate 514 further includes the circumferential wall 520 and a bottom wall 522. The circumferential wall 520 has a cylindrical shape. The circumferential wall 520 is in contact with the outer surface of the electrode 554 to cover the entire outer surface of the electrode 554. The circumferential wall 520 is in contact with the entire inner surface of the recess 516. In this configuration, between the electrode 552 and the electrode 554, the recess 516 and the circumferential wall 520 are positioned. The circumferential wall 520 has a piercing hole 520a that pierces the circumferential wall 520 at a position continuous to the piecing port 554a. The piecing hole 520a makes the piecing port 554a communicate with the groove 516c.

The bottom wall 522 is disposed at the lower end of the circumferential wall 520. The bottom wall 522 is in contact with the bottom surface of the recess 516. The bottom wall 522 is disposed between the lower end of the electrode 554 and the bottom surface of the recess 516. The bottom wall 522 includes the piecing hole 552a that pierces the bottom wall 522 at a position continuous to the piecing hole 516b.

The case 562 blocks the insertion hole 515. Specifically, the case 562 is fitted via an O-ring 506 to the upper end of the recess 516. Consequently, a storage space 510 is formed by the lower end surface of the case 562, the inner surface 554b of the electrode 554, the outer surface 556a of the electrode 556 and the upper surface of the bottom wall 522.

In the case 562, the control device 580 is disposed. The control device 580 includes the control circuit 82, four conducting wires 586 and one terminal 588. The control circuit 82 is housed in the case 562. The control circuit 82 is a circuit for, using the sensor unit 560, detecting the temperature of the fuel and the concentration of alcohol.

The control circuit 82 is electrically connected to a thermistor 558 and the electrodes 554 and 556 that are fixed to the case 562 via the four conducting wires 586. The control circuit 82 is connected to the terminal 588. The terminal 588 is passed from the control circuit 82 through the case 562 and makes contact with the electrode 552. In this way, the electrode 552 is connected to the control circuit 82 via the connection terminal 588.

When the pump main body 34 (see FIG. 1) is operated, as indicated by an arrow in FIG. 6, the fuel in the pipe 52 is passed through the communication hole 516a and a communication hole 522a and flows into the storage space 510. The fuel flowing into the storage space 510 flows between the electrode 554 and the electrode 556 from above to below. Then, the fuel reaching the upper end of the storage space 510 is passed through the communication hole 554a and the communication hole 516b and is discharged to the outside of the storage space 510. The fuel discharged from the communication hole 516b flows within the groove 516c from above to below, and is discharged from the communication hole 516b to the outside of the fuel sensor unit 502.

While the fuel supply unit 1 is being driven, the control circuit 82 uses the electrode pair 550 (that is, uses the signal returned from the electrode 554 via the terminal 558 to the control circuit 82) to repeatedly perform the detection of the concentration of alcohol contained in the fuel and the detection of the temperature of the fuel with the thermistor 558. The shield electrode 552 is grounded via the control circuit 82. In this way, it is possible to reduce the change in the capacitance of the electrode pair 550 caused by influence (for example, an electromagnetic field) outside the shield electrode 552.

The signal returned from the electrode 554 to the control circuit 82 is affected by the capacitance (hereinafter referred to as the “parasitic capacitance”) produced between the electrode 554 and the shield electrode 552. However, because the recess 516 and the circumferential wall 520 formed of resin (that is, insulating material) are disposed between the electrode 554 and the shield electrode 552, the parasitic capacitance is hardly affected by the property of the fuel (for example, the concentration of alcohol and the temperature). Although the fuel is present in the groove 516c, the groove 516c is small as compared with the entire opposing area of the electrodes 554 and 556. Hence, the change in the parasitic capacitance caused by the change in the property of the fuel within the groove 516c is small as compared with the entire parasitic capacitance. The control circuit 82 includes a configuration for removing the effects of the parasitic capacitance (that is, a constant value) from the signal outputted from the electrode 554. With this configuration, it is possible to reduce a detection error caused by a change in the parasitic capacitance.

In the fuel sensor unit 502 of the present embodiment, the shield electrode 552 is fixed, by insert molding, integrally to the set plate 514, and the electrodes 554 and 556 are fixed, by insert molding, integrally to the case 562. Consequently, all the three electrodes 552 to 556 do not need to be fixed, by insert molding, integrally to one of the set plate 514 and the case 562. Consequently, the three electrodes 552 to 556 do not need to be disposed in one forming mold.

(Correspondence Relationship)

The fuel sensor unit 502 and the set plate 514 are examples of the “liquid sensor” and the “lid,” respectively. The electrodes 556, 554 and 552 are examples of the “first electrode,” the “second electrode” and the “third electrode,” respectively. The terminal 588 is an example of the “terminal” and the “supplying unit.”

(Variations of the Fifth Embodiment)

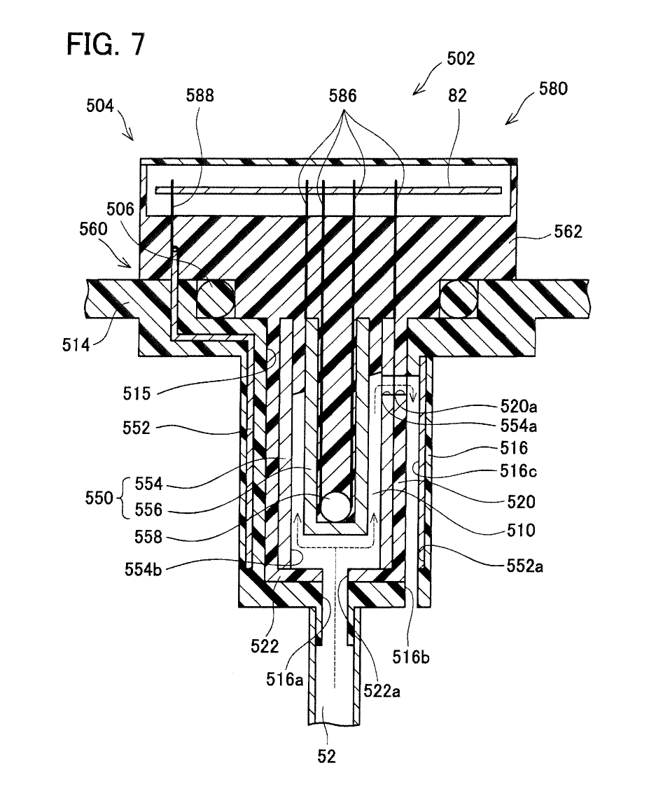

(1) As shown in FIG. 7, the shield electrode 552 may be disposed within the circumferential wall of the recess 516. With this configuration, it is possible to prevent the shield electrode 552 from making direct contact with the fuel. In this way, it is possible to reduce the corrosion of the shield electrode 552.

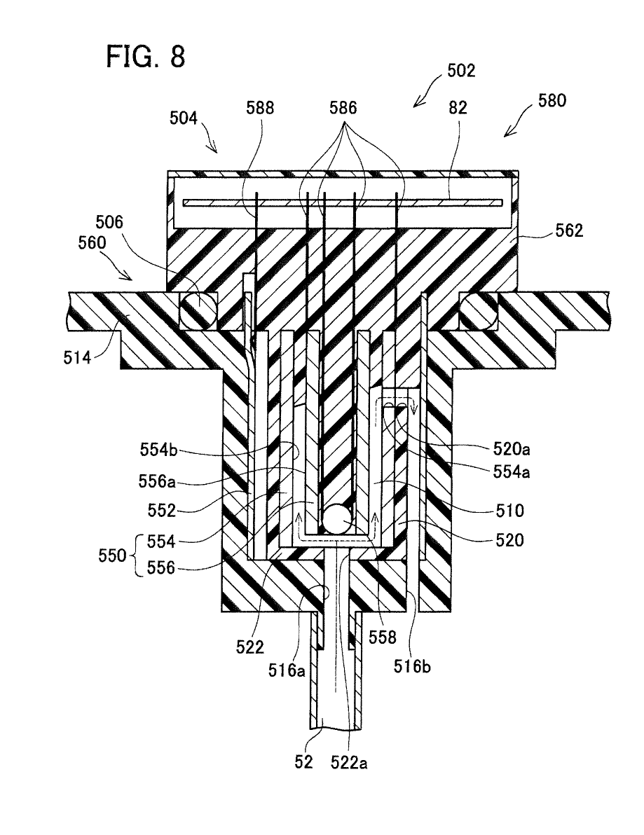

(2) As shown in FIG. 8, the shield electrode 552 may be disposed along the inner surface of the recess 516. In this case, the shield electrode 552 may be in contact with the outer surface of the circumferential wall 520 or may be separated therefrom. Between the circumferential wall 520 and the shield electrode 552, a fuel flow path that makes the piercing port 520 communicate with the piercing hole 516b may be formed.

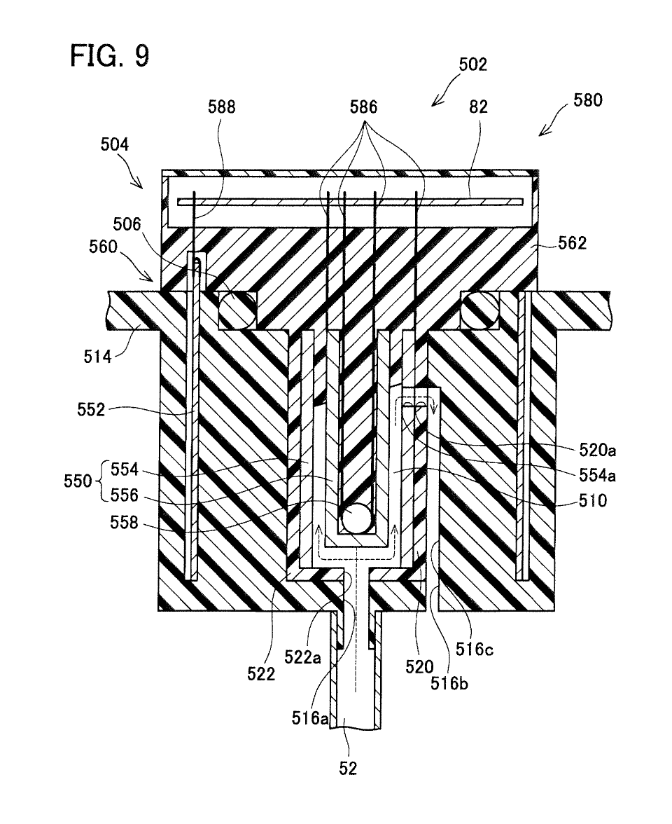

(3) As shown in FIG. 9, the shield electrode 512 may not be bent.

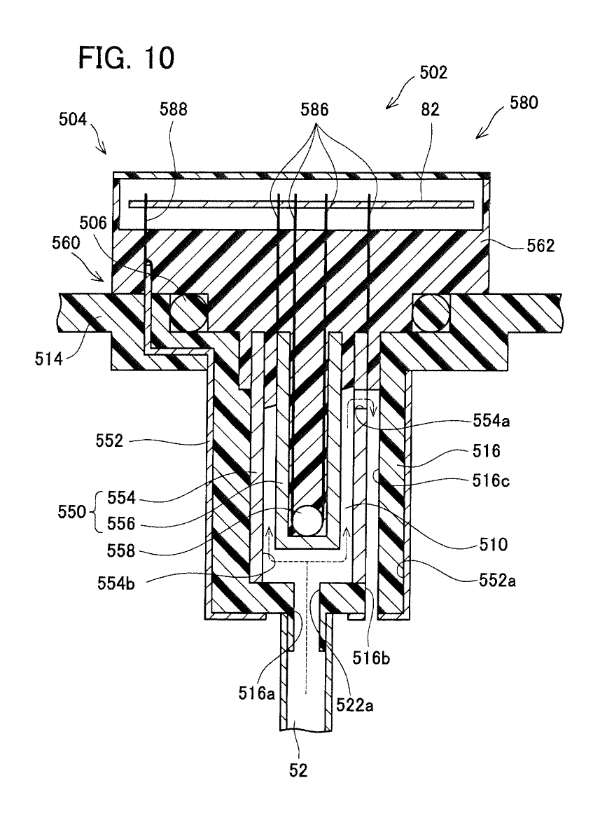

(4) As shown in FIG. 10, the case 562 may not include the circumferential wall 520 and the bottom wall 522. In this case, the electrode 554 may be in contact with the inner surface of the recess 516. The shield electrode 552 may cover the lower end surface of the recess 516.

(5) Between the electrode 552 and the electrode 554 (or the circumferential wall 520), a sealer such as an O-ring may be disposed. With this configuration, it is possible to reduce the occurrence of an event in which, for example and as shown in FIG. 8, the fuel flowing out between the piecing port 554a of the electrode 554 and the electrode 552 is passed from an area between the electrodes 552 and 554, that is, between the electrode 552 and the circumferential wall 520 through an area between the case 562 and the set plate 514 and is discharged to the outside.

(6) The electrode 552 may have the cylindrical shape of a polygon instead of a tubular shape. The electrode 552 may have, for example, a partial tubular shape and cover part of the outer surface of the electrode 554.

### Sixth Embodiment

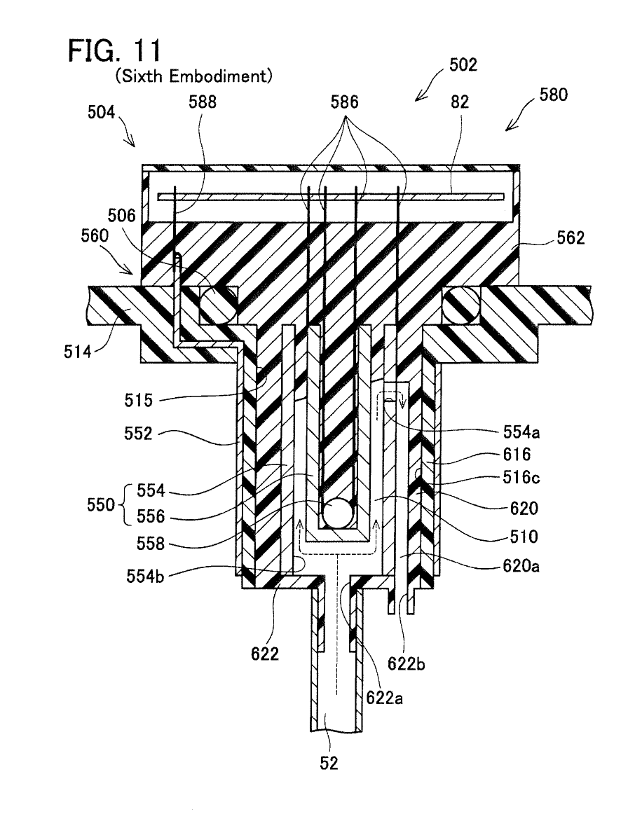

Parts different from the fifth embodiment will be described with reference to FIG. 11. The same configurations as in the fifth embodiment are identified with the same symbols as in FIG. 6 of the fifth embodiment, and their description is omitted. In the sixth embodiment, the configurations of a circumferential wall 620 and a bottom wall 622 each differ from the configuration of the circumferential wall 520 and the bottom wall 522. The sixth embodiment differs from the fifth embodiment in that the set plate 514 includes a tubular unit 616 instead of the recess 516.

As with the circumferential wall 520, the circumferential wall 620 has a cylindrical shape, is in contact with the outer surface of the electrode 554 and covers the entire outer surface of the electrode 554. The circumferential wall 620 has a groove 620a that is disposed to be continuous to the piecing hole 554a. The groove 620a extends downwardly from the same position as the upper end of the piecing hole 554a to reach a bottom wall 662. The groove 620a is in contact with the outer surface of the electrode 554. In this way, the groove 620a forms a fuel path together with the outer surface of the electrode 554. The circumferential wall 620 is thicker than the circumferential wall 520. The other configurations of the circumferential wall 620 are the same as those of the circumferential wall 520.

The bottom wall 622 is disposed at the lower end of the circumferential wall 620. The bottom wall 622 includes a communication hole 622a that communicates with the pipe 52 and a communication hole 622b that communicates with the groove 620a.

The tubular unit 616 is disposed between the circumferential wall 620 and the electrode 552. The cylindrical unit 616 is in contact with the outer surface of the circumferential wall 520 to cover the circumferential wall 520. The cylindrical unit 616 is in contact with the inner surface of the shield electrode 552.

When the pump main body 34 (see FIG. 1) is operated, as indicated by an arrow in FIG. 11, the fuel in the pipe 52 passes through the communication hole 622a and flows into the storage space 510. The fuel flowing into the storage space 510 flows between the electrode 554 and the electrode 556 from below to above. Then, the fuel reaching the upper end of the storage space 510 passes through the communication hole 554a and is discharged to the outside of the storage space 510. The fuel discharged from the communication hole 554a flows within the groove 620a from above to below, and is discharged from the communication hole 622b to the outside of the fuel sensor unit 502.

(Variations)

(1) In the embodiments described above, the electrode 104 and the like have a tubular shape. However, the electrode 104 and the like may have a tubular shape whose cross section is a polygon instead of a tubular shape or may have a flat-plate shape.

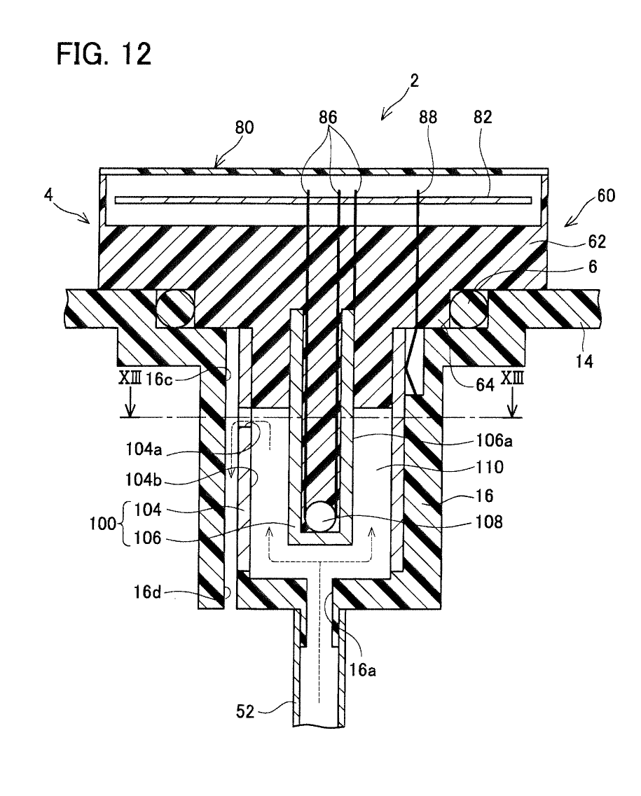

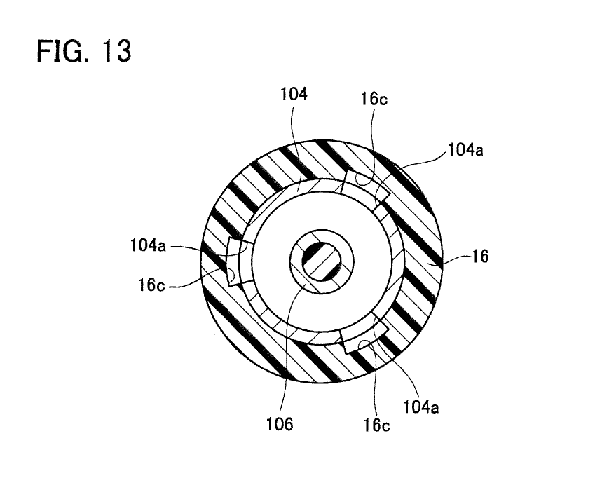

(2) In the first to fourth embodiments, the fuel within the storage space 110 or the like is discharged from the communication hole 16b or the like of the recess 16. However, for example, as shown in FIG. 12, the recess 16 may include a groove 16c and a communication hole 16d instead of the communication hole 16b. The groove 16c may communicate with the communication hole 104a of the electrode 104 and extend downwardly. The groove 16c may define the path of the fuel together with the outer surface of the electrode 104. In the lower end of the groove 16c, the piecing hole 16d piecing the bottom wall of the recess 16 may be formed. In this configuration, the fuel within the storage space 110 or the like may be discharged from the communication hole 104a, may flow through the groove 16c from above to below and may be discharged from the piecing hole 16d to the outside of the fuel sensor unit 2. As shown in FIG. 13, the recess 16 may include two or more grooves 16c and two or more communication holes 16d. In this case, the electrode 104 may include two or more communication holes 104a that each communicate with two or more grooves 16c.

(3) In the embodiments described above, the fuel sensor unit 2 uses the sensor unit 60 to detect the concentration of alcohol in the fuel. However, the fuel sensor unit 2 may detect the degree of the degradation of the fuel (for example, the degree of oxidation of the fuel), the liquid level of the fuel or the like.

(4) The “liquid sensor” may be used to detect the property (for example, the degree of the degradation, the type of cooling water, or the liquid level) of a liquid other than the fuel, for example, cooling water.

(5) In the embodiments described above, the pipe 52 is connected to the pressure regulator 42. However, the pipe 52 may be branched from the pipe 94 or may be connected to the vapor jet of the pump main body 34.

(6) The sensor unit 60 or the like may include four or more electrodes. In this case, one or more first electrodes may be fixed integrally to the set plate 14 and the like, and one or more second electrodes may be fixed integrally to the case 56 and the like. Alternatively, four or more electrodes may include one or more electrodes that are repeatedly and removably fixed to one of the set plate 14 and the case 56.

(7) In the embodiments described above, the control circuit 82 uses the capacitance of each electrode pair, that is, the dielectric constant of the fuel to detect the concentration of alcohol or the like. However, the control circuit 82 may use a value obtained by using an electrode pair other than the capacitance of the electrode pair, for example the conductivity of the fuel obtained by using the electrode pair, to detect the concentration of alcohol.

(8) In the embodiments described above, the control circuit 82 detects the concentration of alcohol or the like. However, the circuit for detecting the concentration of alcohol may be disposed outside the sensor device 4 (for example, an ECU (abbreviation of Engine Control Unit). In this configuration, the control circuit 82 may supply the signal returned from the electrode pair 100 to the external circuit. In the present variation, the control circuit 82 is an example of the “supplying unit.”

(9) In the embodiments described above, as the “sealer,” the O-ring 6 or 6a is used. However, as the “sealer,” instead of the O-ring 6 or 6a, an item that is coated with a sealing agent or the like may be used. In general, the “sealer” is preferably a member that blocks a gap so as not to let any liquid flow out therefrom.

What is claimed is:

1. A liquid sensor configured to detect a liquid property within a container, the liquid sensor comprising:
a lid disposed at an opening of the container, and having an insertion hole;
a control circuit;
a case housing the control circuit, and being assembled with the lid;
a first electrode integrally fixed to the case, and protruding from the case so as to be positioned on a container side of the insertion hole;
a second electrode integrally fixed to the lid, and opposing the first electrode with an interval in between; and
a terminal extending from the control circuit and extending through the case, and electrically in contact with the second electrode.

2. The liquid sensor as in claim 1, wherein
the lid comprises a recess housing the first electrode on the container side of the insertion hole, and
the second electrode is fixed to the recess.

3. The liquid sensor as in claim 1, wherein
the first electrode and the second electrode define a storage space configured to store liquid, and
the liquid sensor further comprises:
a supplying unit configured to supply an output value being output from one of the first electrode and the second electrode to a detecting unit configured to detect the property of the liquid while electric power is supplied to one of the first electrode and the second electrode.

4. The liquid sensor as in claim 3, further comprising:
a sealer disposed between the first electrode and the second electrode, and blocking the interval between the first electrode and the second electrode from communicating with a gap between the lid and the case.

5. The liquid sensor as in claim 3, further comprising:
a sealer disposed between the insertion hole and the first electrode, and blocking the storage space from communicating with a gap between the lid and the case.

6. The liquid sensor as in claim 1, further comprising:
a third electrode integrally fixed to the case, and opposing the first electrode with an interval in between; and
a supplying unit configured to supply an output value outputted from one of the first electrode and the third electrode to a detecting unit configured to detect the property of the liquid while electric power is supplied to one of the first electrode and the third electrode,
wherein the first electrode and the third electrode define a storage space configured to store liquid, and
the second electrode is a shield electrode for the first electrode and the third electrode.

7. The liquid sensor as in claim 6, further comprising:
a sealer disposed between the first electrode and the second electrode, and blocking the interval between the first electrode and the second electrode from communicating with a gap between the lid and the case.

8. The liquid sensor as in claim 6, further comprising:
a sealer disposed between the insertion hole and the first electrode, and blocking the storage space from communicating with a gap between the lid and the case.

9. The liquid sensor as in claim 1, wherein
the second electrode includes a first surface opposing the first electrode and a second surface being on an opposite side to the first surface,
the terminal contacts the second surface, and
at least a portion of the second surface contacting the terminal is inclined toward the terminal in greater degree as the second surface extends farther away from the case.
